(19) United States
(12) Patent Application Publication
(10) Pub. No.: US 2021/0390534 A1
(43) Pub. Date: Dec. 16, 2021

(54) SYSTEMS AND METHODS FOR ENCODING DATA IN AN ELECTRONIC TRANSACTION

(71) Applicant: Coded Data Limited, Hamilton (NZ)

(72) Inventors: Richard Mark ASHCROFT, Hamilton (NZ); Trevor John LOGAN, Hamilton (NZ)

(73) Assignee: Coded Data Limited, Hamilton (NZ)

(21) Appl. No.: 17/286,342

(22) PCT Filed: Oct. 17, 2019
(86) PCT No.: PCT/NZ2019/050136

§ 371 Date: Apr. 16, 2021

(30) Foreign Application Priority Data
Oct. 17, 2018 (NZ) 747365

(51) Int. Cl. G06Q 20/38; G06Q 40/00; G06Q 40/02; G06F 40/174

(52) U.S. Cl. CPC G06Q 20/389; G06F 40/174; G06Q 40/02; G06Q 40/123

(57) ABSTRACT

Methods and systems are described for providing data with a payment transaction. A dataset for inclusion with a payment transaction is received. The dataset is encoded, and at least one free text field of a payment transaction interface is populated with the encoded dataset. Once the free text field(s) are populated with the encoded dataset, the payment transaction is performed.

### STATEMENT OF CORRESPONDING APPLICATIONS

This application is based on the provisional specification filed in relation to New Zealand Patent Application No. 747365 the entire contents of which are incorporated herein by reference.

### TECHNICAL FIELD

The present disclosure relates to systems and methods for encoding data within restricted input text fields associated with an electronic transaction in a computing environment, more particularly using a binary-to-text encoding method.

### BACKGROUND

There are numerous forms of financial transactions which require the completion of documentation in addition to the actual provision or receipt of payment. These tasks are often performed separately, and therefore necessitate a reconciliation process, which consumes resources of the parties involved. In the context of governmental revenue agencies (e.g. a taxation authority), the volume of transactions involved can present a significant burden to the agency. For the party initiating the transaction (e.g. a tax paying entity), the burden presented by the current processes can lead to less than optimal compliance in terms of timeliness, accuracy, and record keeping—or at least impose significant costs in achieving such compliance.

Further, in an increasingly digitised business environment, users of services for the management of data relating to finances have high expectations for the integrity and accessibility of those services. A variety of accounting software packages and services are available, a number of which are capable of importing transaction data from bank records. In each case, these are separated from the banking services themselves. This creates additional points of entry through which data breaches may occur.

It is an object of the present invention to address the foregoing problems or at least to provide the public with a useful choice.

Further aspects and advantages of the present invention will become apparent from the ensuing description which is given by way of example only.

### SUMMARY OF THE DISCLOSURE

The present disclosure may have application to payment transactions initiated by an entity via a user interface provided by an online banking service. The entity initiating such transactions is typically provided with free text fields for the entry of information to accompany the transaction—i.e. data fields in which characters may be entered at the discretion of the entity, rather than being prepopulated. Embodiments of the present disclosure will be described in the context of New Zealand banking transaction standards (more particularly, the BACHO record format), in which three free text fields are provided, each allowing 12 characters (i.e. a total of 36 characters per transaction)—commonly referred to as the “Particulars”, “Code” and “Reference” fields. However, it should be appreciated that the disclosure of the present application may be readily applied to other transaction standards in which a different number of free text fields and/or number of characters are defined.

It should be appreciated that reference to a payment transaction is intended to include transactions initiated by a payee, such as a direct debit, in addition to those initiated by a payer.

According to various aspects of the present disclosure, these free text fields may be utilized to leverage bank infrastructure for the provision of previously uncontemplated functions and services. A large and growing portion of the global population has a bank account and access to online banking services. Because of the importance of banking institutions to financial stability, banks are highly regulated. As a result, their systems are highly secure in terms of processes for authorisation of transactions, and also the integrity of transmitted and stored data. There are numerous commonalities to the services offered by banks within a country or region, providing a common platform for implementation of the present disclosure. Also, the online banking payment process is typically standardised across all banks within a country, providing a common carrier of data. It is within this context that aspects of the present disclosure are described herein.

For completeness, it should be appreciated that use of the term “bank” is not intended to exclude use of the present disclosure with non-bank financial institutions providing payment services through an online interface.

According to one aspect of the present disclosure there is provided a method for providing data with a payment transaction, the method comprising: utilizing at least one processor to execute computer code that performs the steps of: receiving a dataset for inclusion with a payment transaction; encoding received dataset; populating at least one free text field of a payment transaction interface with the encoded dataset; and performing the payment transaction.

In an exemplary embodiment, at least a portion of the dataset may be extracted from a form. For example, the form may be provided by at least one or more of: an online form of the user interface provided by an online banking service, a form document uploaded to the online banking service, and a form of a third-party application (for example, an accounting software platform, a dedicated encoding service, or a service that creates direct debits to be withdrawn from an account). In the case of external services, it is envisaged that these may communicate with the online banking service (for example, via an API), or may produce the encoded dataset for entry into the free text fields by a user.

It is envisaged that the encoding may perform two key functions. Firstly, the total number of characters in the free text fields is limited, and encoding may provide compression for the dataset where required. Further, the dataset needs to be suitable for entry into the free text field(s). Banking transaction standards typically restrict the entry of certain characters in the free text field—encoding may be used to ensure the data complies with these requirements.

In an exemplary embodiment, the dataset may be encoded using binary-to-text encoding. It is envisaged that the data may be encoded using a Base64 encoding method. Base64 represents binary data in an ASCII string format by translating it into a radix-64 representation. Each Base64 character represents exactly 6 bits of data. Three 8-bit bytes (i.e. a total of 24 bits) can therefore be represented by four 6-bit Base64 characters. Base64 is envisaged as being particularly applicable to embodiments in which a limited character set is available for the user defined free text fields, for example: 0-9, a-z, A-Z and a limited number of special characters. It will be appreciated that reference to use of Base64 encoding is not intended to be limiting to all embodiments of the present disclosure. For example, it is envisaged that other standards such as Ascii85 could be used in systems that allow for use of an extended set of special characters in the ASCII character set. For completeness, it should also be appreciated that the binary-to-text encoding may include first converting the dataset into a binary form.

In an exemplary embodiment the encoding may be performed in accordance with one of a plurality of protocols. It is envisaged that the present disclosure may be utilized to perform a plurality of tasks and/or functions. In each case, the content and/or form of the dataset to be included may differ. It is envisaged that a payment transaction may include a protocol type identifier, identifying the protocol to be used in processing the payment transaction and decoding the encoded dataset. In an exemplary embodiment, a payment transaction may include a protocol version identifier, identifying the version of the type of protocol being utilised. In exemplary embodiments, each payee entity utilising the present disclosure may have its own set of protocols.

In an exemplary embodiment, the protocols themselves may be stored as data encoded in one or more payment transactions. It is envisaged that such transactions may be made to (i.e. stored in) a dedicated bank account. It is envisaged that this may assist with leveraging the security of the banking system to secure the protocols. Controls can be put in place to validate protocols—for example submission by authorised payers to that account. Also, being write-only, the protocol files cannot be corrupted or easily modified by a third party. A ‘Protocol Files Bank Account’ may be established at each trading bank, forming a distributed ledger of protocol files and providing a local store for that trading bank. It is further envisaged that the protocol files may be distributed across multiple sub accounts to group them based on certain criteria.

In an exemplary embodiment the payment transaction may include control information. The protocol type identifier may be one example of control information. In an exemplary embodiment, the control information may include a transaction type identifier for identifying the transaction as being one which includes an encoded dataset of the present disclosure. Bank payment transactions typically include a “record type” and/or “transaction code” field identifying the nature of the transaction. It is envisaged that one of these fields may be used to provide the transaction type identifier of the present disclosure.

In an exemplary embodiment the payment transaction may include a unique transaction identifier for identification of the transaction as being one utilising the methods of the present disclosure. It is envisaged that the unique transaction identifier may be produced using a standardised technique to provide a uniform format—in contrast with the transaction identifier or reference number commonly utilised by banks (the format of which may differ between individual banks).

In an exemplary embodiment, a record resulting from a payment transaction may include an index key for identifying the transaction when the data in a single transaction is broken into header and record tables.

In an exemplary embodiment, encoding flags may be provided to identify whether optional data fields have been populated. For example, a form may include nine optional fields, each of which may be eight bits in size. Where one or more of such fields are not populated, then this may be identified using the encoding flags, and these bits of data may be utilized for other information. This ‘other information’ may be, for example, a portion of information from another transaction that would otherwise extend to multiple transactions. It is envisaged that the ‘other information’ would be in the protocol specification, and could be placed in the first payment transaction rather than subsequent supplementary transactions of a nominal amount—e.g. a smallest value permitted.

In an exemplary embodiment, the encoded dataset may be provided in more than one payment transaction. It is envisaged that the size of the encoded dataset may exceed the characters available in the free text fields of a single transaction. In such cases, the free text fields of another transaction may be used to complete the dataset. Conversely, it is also envisaged that multiple records may be included in a dataset provided in a single payment transaction.

It should be appreciated that details of single transactions may be processed and transmitted separately—but in some cases may be included in a batch payment file.

It is envisaged that the records produced from incoming and outgoing payment transactions of the present disclosure may act as a database. More particularly, the structured data in the records may be used to form a relational database. It is envisaged that multiple relational databases may be stored in, and retrieved from, a single table of stored structured data—i.e. the present disclosure may be used to provide a vertical database. A user's transactions form a single table, within which each row has fields utilised by the system of the present disclosure to store encoded data. The decoded information, within the row, may form the header and/or records of a relational database. This data may also have a relationship to the decoded data within one or many other transactions in the same user's transaction table. Thus, from a single table (or vertical database) with a constrained record set, a more complex relational database can be formed.

In an exemplary embodiment, the vertical database formed by a collection of encoded transactions may function as a non-relational NoSQL document store database. The contents of each encoded transaction may include the data for an individual document whose definition is described by a predefined protocol. An encoded identification within the encoded free text fields, and the supporting transaction fields, may provide the data required to identify the predefined protocol. Each encoded transaction record may have a different protocol, and therefore a table of encoded transactions (once decoded) will form a collection of documents with varying definitions (i.e. a non-relational NoSQL document store database).

In an exemplary embodiment, an encoded transaction may be used to generate a document. For example: the document may be a receipt, an invoice, a statement, or any other document which may be relevant to the transaction. In exemplary embodiments, an encoded transaction may identify a protocol to be used to generate the document. In exemplary embodiments, generation of the document may include calling one or more third-party application programming interfaces to obtain additional information based on data included in the encoded dataset of the transaction.

In an exemplary embodiment, the payment transaction may relate to a tax return—more particularly a goods & services tax (GST), or value-added tax (VAT), return. In many jurisdictions, payment of tax requires completion of accompanying documentation. It is envisaged that the encoded dataset of the payment transaction may include requisite information to complete a tax return.

In such an embodiment, the payment transaction may be for the value of the tax owing with the return. However, it is also envisaged that the present disclosure may allow for submission of a tax return requesting a refund. In this case, it is envisaged that the payment transaction may be for a nominal amount—e.g. a smallest value permitted—such that the primary function of the transaction is the conveyance of the dataset.

By utilising the present disclosure, a tax return may be submitted and paid in the same process. It is envisaged that this may reduce the administrative burden on the entity completing the return, as well as reducing the resource required by the taxation agency to complete reconciliation processes. Further, records of the tax return and associated payment are stored at the same location—and these records are duplicated between the parties involved.

In an exemplary embodiment, the payment transaction may relate to a payment to an approved charitable organisation, and include a request for a donation tax credit (also known as a charitable contribution deduction) from a taxation authority. Reference to an approved charitable organization should be understood to mean an organization which has met requirements under the applicable tax code to be eligible for tax exemptions—more particularly such that donors are eligible for a tax credit in relation to donations made to that organization.

It is envisaged that a first payment transaction to an approved charitable organization may initiate a second payment transaction to a taxation authority, wherein an encoded dataset of the second payment transaction may include requisite information to complete a request for a donation tax credit.

In an exemplary embodiment, the payment transaction may relate to a payment of withholding tax on interest to a taxation authority. It is envisaged that payment of interest subject to a withholding tax may include a first payment transaction to an account relating to a deposit accruing interest, and a second payment transaction to a taxation authority, wherein an encoded dataset of the second payment transaction may include requisite information to complete a withholding tax certificate.

Currently, interest paid on deposits requires a deduction of tax against the interest paid, that is collected and forwarded to the tax agency on a monthly reporting and payment basis by the bank. At the end of the financial year, a detailed statement is forwarded to the tax agency to identify the tax payer entity (i.e. the entity subject to the withholding tax), the amount of interest paid, the amount of tax deducted, and the tax rate applied. A reconciliation is also carried out to match the deductions against the returned amounts.

It is envisaged that the use of the present disclosure to pay the deducted interest at the time of interest payment may have one or more benefits over the existing arrangement. For example, the administrative burden of collecting and paying accrued deductions and maintaining multiple sets of records may be reduced by attending to agency requirements at the time of interest being paid. The associated records are updated regularly, and mirrored between the taxation agency, the interest payor, and the payee. Further, it is envisaged that the regular submission of this information may enable early detection of errors in the tax rate applied in comparison with situations in which documentation is returned annually.

In an exemplary embodiment, the payment transaction may relate to withholding tax on income payments to employees—i.e. pay-as-you-earn (PAYE). In many jurisdictions, income tax is withheld by employers and paid to the relevant taxation agency, which requires completion of documentation regarding the payments. It is envisaged that the encoded dataset of the payment transaction may include requisite information to complete the documentary requirements. In such an embodiment, the payment transaction may be for the value of the tax owing.

In an exemplary embodiment, the payment to the employee, and the payment to the taxation agency, may be performed on completion of a single form. However, it should be appreciated that this is not intended to exclude performance of the respective payments as the result of distinct actions.

In an exemplary embodiment, a payment transaction may be made to an account of the payer in order to record the dataset within the account records. It is envisaged that such a payment transaction may be made to the same account from which the payment is made, in order that the net effect on the account balance is zero. However, it should be appreciated that this is not intended to be limiting, as it is also envisaged that the payment may be made to another account or sub-account of the payer—or that payments may be made by a third party (for example, an accounting service). Regardless, it is envisaged that the value of such a payment transaction may be a nominal amount—e.g. a smallest value permitted—such that the cost of performing such payments is minimal.

It is envisaged that protocols may be provided for the formation of different types of records, examples of which are described herein.

In an exemplary embodiment, a payment transaction may be used to establish one or more accounting codes to be applied to other transactions. Reference to an accounting code should be understood to be a classifier of the transaction for accounting purposes.

In an exemplary embodiment, a payment transaction may be used to apply an accounting code to an earlier transaction—i.e. producing a new accounting coded record associating the accounting code with the earlier transaction. The accounting coded record may include data identifying the earlier transaction. The accounting coded record may further include data uniquely identifying the record, such that it may be distinguished from further accounting coded records produced for the same earlier transaction (for example, produced when correcting or updating the accounting code applied).

In exemplary embodiments, a payment transaction may be used to apply an accounting code to an entire earlier transaction, or a portion of the earlier transaction.

In an exemplary embodiment, a payment transaction may be used to adjust a tax treatment of an earlier transaction. For example, the resulting record may associate the earlier transaction with a designated tax period, and/or a registered tax number.

In an exemplary embodiment, a payment transaction may be used to provide an accounting journal entry. The accounting journal entry is not directly linked to an earlier payment transaction. A journal entry allows for the transfer of monies between accounting codes without being attached to a specific transaction—for example, a journal entry for depreciation.

In an exemplary embodiment, a payment transaction may be used to apply a customised note to an earlier transaction—i.e. producing a new record associated with the earlier transaction, wherein the new record includes a customised note. By way of example, such notes may be used to provide commentary when applying a code or making a journal entry explaining why that change was made.

In an exemplary embodiment, the encoded dataset may be used to enrich a transaction line item of an online banking interface. Such transaction line items are typically displayed in a plain text format. In addition to enabling the display of more detailed information than is currently available, it is envisaged that the encoded dataset may be used to define visuals and/or graphical elements of a transaction line item. For example, the dataset may be used to define visual elements such as background colour. In exemplary embodiment, the line item may include a graphical element such as a logo or a graph (for example, a graph of power usage over time in a line item relating to a payment of a power bill).

In an exemplary embodiment, the encoded dataset may relate to an image. More particularly, it is envisaged that an image may be encoded into a text string capable of being entered into the free text field(s), and reconstructed from the resulting record. It should be appreciated that the image may be obtained from a number of sources, including a library of suitable images, uploading, or creation of same in a user interface.

In an exemplary embodiment, the payment transaction may relate to payment of an invoice. It is envisaged that the encoded dataset may include details relating to the invoice, which may be used to produce a receipt.

In an exemplary embodiment, the payment transaction may relate to payment of dividends. It is envisaged that the encoded dataset may include details which may be used to produce a dividend statement.

It should be appreciated that the exemplary uses of the present disclosure are not intended to be limiting, as it is contemplated that the dataset may include essentially any information capable of being encoded into a format to suit the free text field(s) of the payment transaction. For example, the dataset may include one or more of: payslip data, payroll data, invoicing, document links, website links, and regulatory required notifications to authorities.

According to one aspect of the present disclosure there is provided a system for providing data with a payment transaction, the system comprising: at least one processor; and a computer readable storage medium having computer readable program code embodied therewith and executable by the at least one processor, the computer readable program code comprising: computer readable program code that receives a dataset for inclusion with a payment transaction; computer readable program code that encodes the received dataset; computer readable program code that populates at least one free text field of a payment transaction interface with the encoded dataset; and computer readable program code that performs the payment transaction.

According to one aspect of the present disclosure there is provided a computer program product for providing data with a payment transaction, the computer program product comprising a computer readable storage medium having computer readable program code embodied therewith, the computer readable program code comprising: computer readable program code that receives a dataset for inclusion with a payment transaction; computer readable program code that encodes the received dataset; computer readable program code that populates at least one free text field of a payment transaction interface with the encoded dataset; and computer readable program code that performs the payment transaction.

### BRIEF DESCRIPTION OF THE DRAWINGS

The detailed description of the drawings refers to the accompanying figures in which:

FIG. 1 is a schematic illustration of an exemplary computing system in which embodiments of the present disclosure may be implemented;

FIG. 2 is a schematic illustration of an exemplary architecture in which embodiments of the present disclosure may be implemented;

FIG. 3 is a flow diagram of an exemplary method for providing data with a payment transaction;

FIG. 4-1 is an exemplary user interface for payment of goods and services tax;

FIG. 4-2 is an exemplary user interface for data collection for inclusion in the payment of goods and services tax;

FIG. 4-3 is an exemplary entity relationship diagram within the system;

FIG. 5 is an exemplary user interface for payment of payroll;

FIG. 6 is an exemplary user interface for payment of donations;

FIG. 7 illustrates exemplary enriched transaction line items of an online banking interface;

FIG. 8 is an exemplary user interface for account code creation and modification;

FIG. 9 is an exemplary user interface for application of accounting codes;

FIG. 10 is another exemplary entity relationship diagram within the system;

FIG. 11 is another exemplary entity relationship diagram within the system;

FIG. 12 is an exemplary user interface for journal entry creation;

FIG. 13 is another exemplary entity relationship diagram within the system;

FIG. 14-1 is an exemplary user interface for accessing stored documents;

FIG. 14-2 is a first example of a stored document, and

FIG. 14-3 is a second example of a stored document.

### DETAILED DESCRIPTION OF THE DRAWINGS

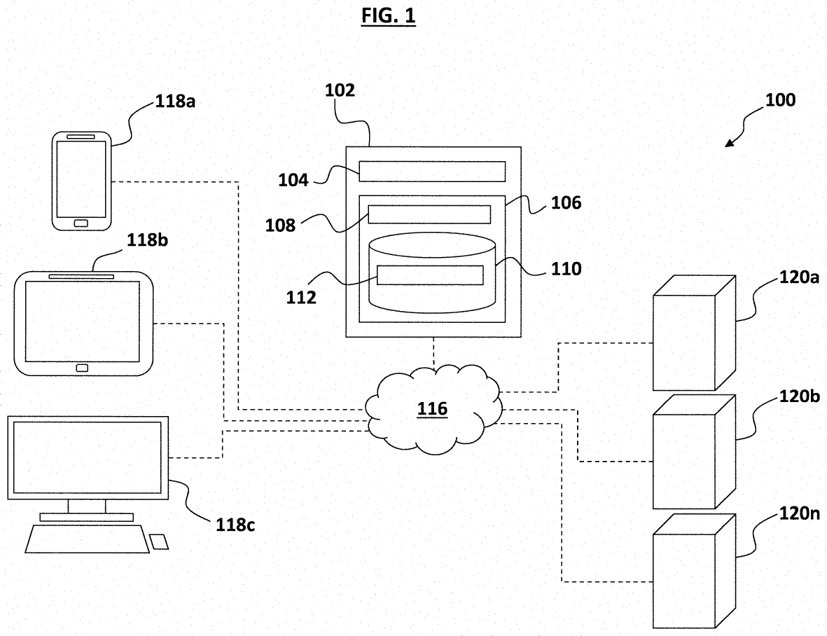

FIG. 1. presents a schematic diagram of a system 100 depicting various computing devices that can be used alone or together in accordance with exemplary embodiments of the disclosure. The system 100 includes a payment transaction data service 102, illustrated in this exemplary embodiment as being implemented in a server—for example one or more dedicated server devices, or a cloud based server architecture.

By way of example, the server(s) implementing the service 102 may have processing facilities represented by processors 104, memory 106, and other components typically present in such computing environments. In the exemplary embodiment illustrated the memory 106 stores information accessible by processors 104, the information including instructions 108 that may be executed by the processors 104 and data 110 that may be retrieved, manipulated or stored by the processors 104. The memory 106 may be of any suitable means known in the art, capable of storing information in a manner accessible by the processors, including a computer-readable medium, or other medium that stores data that may be read with the aid of an electronic device. The processors 104 may be any suitable device known to a person skilled in the art. Although the processors 104 and memory 106 are illustrated as being within a single unit, it should be appreciated that this is not intended to be limiting, and that the functionality of each as herein described may be performed by multiple processors and memories, that may or may not be remote from each other.

The instructions 108 may include any set of instructions suitable for execution by the processors 104. For example, the instructions 108 may be stored as computer code on the computer-readable medium. The instructions may be stored in any suitable computer language or format. Data 110 may be retrieved, stored or modified by processors 104 in accordance with the instructions 108. The data 110 may also be formatted in any suitable computer readable format. Again, while the data is illustrated as being contained at a single location, it should be appreciated that this is not intended to be limiting—the data may be stored in multiple memories or locations. The data 110 may include databases 112.

The service 102 may communicate with external devices and services, via a network 116 potentially comprising various configurations and protocols including the Internet, intranets, virtual private networks, wide area networks, local networks, private networks using communication protocols proprietary to one or more companies—whether wired or wireless, or a combination thereof. The service 102 may communicate with user devices via the network 116, for example smartphone 118a, tablet computer 118b, or personal computer 118c to provide access to functionality and data of the service 102. The service 102 may further communicate with external services 120a-n.

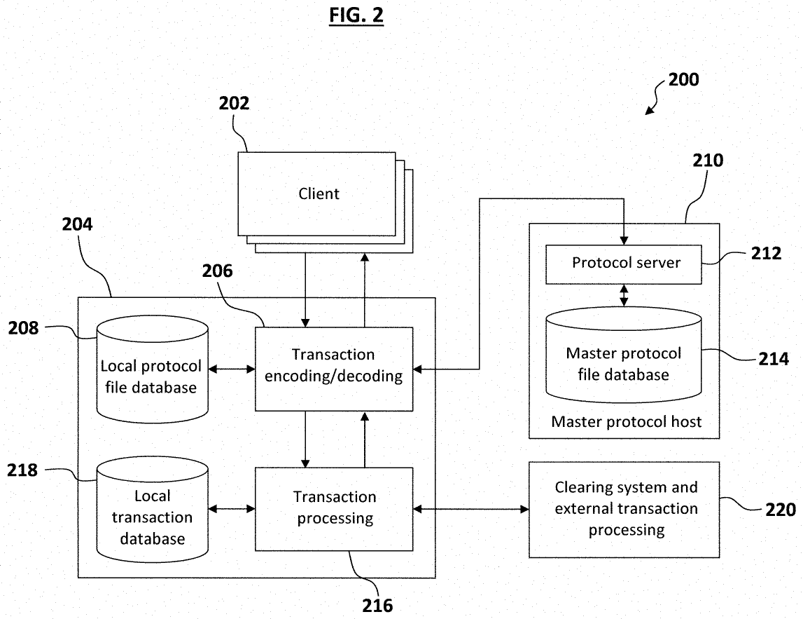

FIG. 2 illustrates an exemplary system architecture 200 for implementation of the service 102. The architecture 200 includes a user interface(s) accessed by client devices 202 (for example smartphone 118a, tablet computer 118b, or personal computer 118c) to enable user access to online banking services provided by the systems of the user's banking provider 204. By way of example, in various embodiments the user interface may be provided by way of: a native application, a web application, or a hybrid application.

The service 102 provides means for encoding a dataset and populating the free text fields of payment transactions initiated by users of the online banking service—as will be described further below. In an exemplary embodiment the encoding and decoding is performed in accordance with one of a plurality of protocols, with payment transactions including a protocol type identifier which identifies the protocol to be used in processing the payment transaction and decoding the encoded dataset.

The bank system 204 includes a transaction encoding/decoding module 206, configured to encode and decode transactions in accordance with the present disclosure. As part of its function, the encoding/decoding module 206 calls on a local protocol file database 208 to return a protocol for a particular transaction based on the protocol type identifier. If the protocol type identifier is not found in the local protocol file database 208, the transaction encoding/decoding module 206 may call on a master protocol host 210. It is envisaged that the master protocol host 210 may be provided as an external service, improving ease of access by various banking providers (and other systems utilising the protocols) to provide means for consistent formatting of the data across multiple platforms. In an exemplary embodiment the master protocol host 210 may include a protocol server 212 managing access to a master protocol file database 214. As an alternative to providing an external protocol host, the protocols themselves may be stored as data encoded in one or more payment transactions in a dedicated bank account.

The banking system 204 further includes a transaction processing module 216 interfacing with the transaction encoding/decoding module 206 to manage incoming and outgoing transactions (including internal transactions). The transaction processing module 216 interfaces with a local transaction database 218 to manage storage and retrieval of data associated with the user related transactions, and potentially clearing system and external transaction processing services 220 for processing of external transactions.

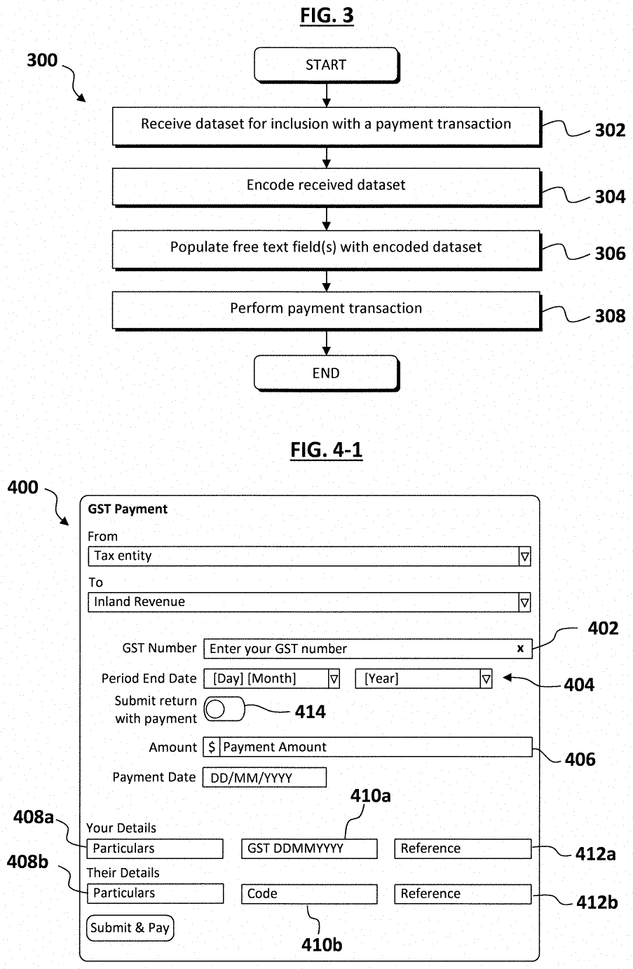

FIG. 3 illustrates a method 300 for providing data with a payment transaction. In a first step 302, a dataset is received for inclusion with a payment transaction initiated via a payment transaction interface of the online banking service of the banking system 204. In a second step 304, the received dataset is encoded. In a third step 306, at least one free text field of a payment transaction interface is populated with the encoded dataset. In a fourth step 308, the payment transaction is performed. It should be appreciated that a corresponding method may be performed for processing a received payment transaction including text fields populated by an encoded dataset in accordance with the method 300.

Exemplary embodiments in which the method 300 may be implemented are described herein. These embodiments will be described in the context of New Zealand banking transaction standards (more particularly, the BACHO record format), in which three free text fields are provided, each allowing 12 characters (i.e. a total of 36 characters per transaction)—commonly referred to as the “Particulars”, “Code” and “Reference” fields. However, it should be appreciated that the disclosure of the present application may be readily applied to other transaction standards in which a different number of free text fields and/or number of characters are defined. Further, the exemplary embodiments will be described as utilising a Base64 encoding method. While Base64 is considered to be well suited to use with formats such as BACHO, it will be appreciated that this is not intended to be limiting to all embodiments of the present disclosure.

FIG. 4-1 and FIG. 4-2 illustrate an exemplary embodiment in which the payment transaction relates to a tax return—more particularly a goods & services tax (GST) return requiring completion of accompanying documentation. It is envisaged that the encoded dataset of the payment transaction may include requisite information to complete a tax return. It should be appreciated that the data to be included for the purposes of completing the documentation will be largely dependent on the requirements of the jurisdiction in question. The present embodiment is described in the context of current New Zealand requirements, and reference may be made to the New Zealand taxation authority: the Inland Revenue Department (IRD).

Exemplary data fields to be included with the payment transaction are outlined in Table 1 below:

TABLE 1

| Field Name | Field Type | Field Length | Field Description |
|---|---|---|---|
| TransactionDate | Numeric | 8 | The date of the bank transaction |
| | | | containing the GST Payment Return in the |
| | | | format 20180726 (YYYYMMDD) |
| PayerName | Alphanumeric | 74 | The name of the GST payer |
| PayerAccountNum | Alphanumeric | 16 | Payer's bank account number |
| PaymentAmount | Decimal | 14 | The GST payment amount |
| IRDNumber | Numeric | 9 | Payer's IRD Number, a validated eight or |
| | | | nine digit number |
| PeriodEndDate | Numeric | 8 | The end date of the period that the GST |
| | | | return and payment are for, in the format |
| | | | (YYYYMMDD) |
| RefundDue | Boolean | 1 | If a refund is due, then TRUE else FALSE. |
| | | | If TRUE, then PaymentAmount will be |
| | | | 0.01 |
| NilReturn | Boolean | 1 | If is a Nil Return then TRUE else FALSE |
| FinalReturn | Boolean | 1 | If is a Final Return then TRUE else FALSE |
| Income | Decimal | 14 | Total income for the GST period |
| Expense | Decimal | 14 | Total expense for the GST period |
| ZeroRated | Decimal | 14 | Total zero rated for the GST period |
| CreditAdjustment | Decimal | 14 | Total credit adjustments for the GST |
| | | | period |
| DebitAdjustment | Decimal | 14 | Total debit adjustments for the GST |
| | | | period |

In this exemplary embodiment, control information to be provided with the payment transaction includes a form identifier used to identify the appropriate protocol for encoding and decoding of the text fields. In an exemplary embodiment the form identifier may include:
Transaction code: a unique three-digit identifier used by banks to identify distinct types of transactions, with a unique 3-digit ID will be introduced to identify transactions as utilising the present disclosure;
Payee name: the name of the entity with which the protocol is associated;
Type: the type of protocol;
Version: the version of the protocol, which each protocol type potentially having a plurality of versions.

In such an embodiment the form identifier may be formatted as: [TransactionCode]_[PayeeName]_[Type]_[Version].

In exemplary embodiments, a record resulting from a payment transaction may include an index key for identifying the transaction when the data in a single transaction is broken into header and record tables. By way of example, the index key may include:
Transaction date: the date of the transaction, more particularly formatted as YYYYMMDD.
Payer account number: the bank account number of the payer—for example a 16-digit number made up of the following, all padded with leading zeros: [Bank(2)][Branch(4)][Number(7)][Suffix(3)];
Type: the type of protocol;
Version: the version of the protocol,
Count (“Nth”): the Nth number of GST Payment Returns made by the same bank account and IRD number on the same day—for example, starting at zero and incrementing with each subsequent return.
IRD Number: the IRD Number of the payer—for example, a 9-digit number padded with leading zeros.
PeriodEndDate—The period end date of the return, formatted as YYYYMMDD.

In such an embodiment the index key may be formatted as: [Transaction Date]_[PayerAccountNum]_[Type]_[Version]_[Nth]_[IRDNumber]_[PeriodEndDate].

In an exemplary embodiment, encoding flags may be provided to identify whether optional data fields have been populated, and if not these these bits of data may be utilized for other information.

When fields, such as monetary fields, are required to accommodate a wide range of values to cater for varying scales (for example: $0.00-$9,999,999.00), the bits required for the maximum value may be unused for lower values. It is envisaged that a plurality of bands across the range may be provided (each having a known number of bits), and identified depending on the value to be recorded.

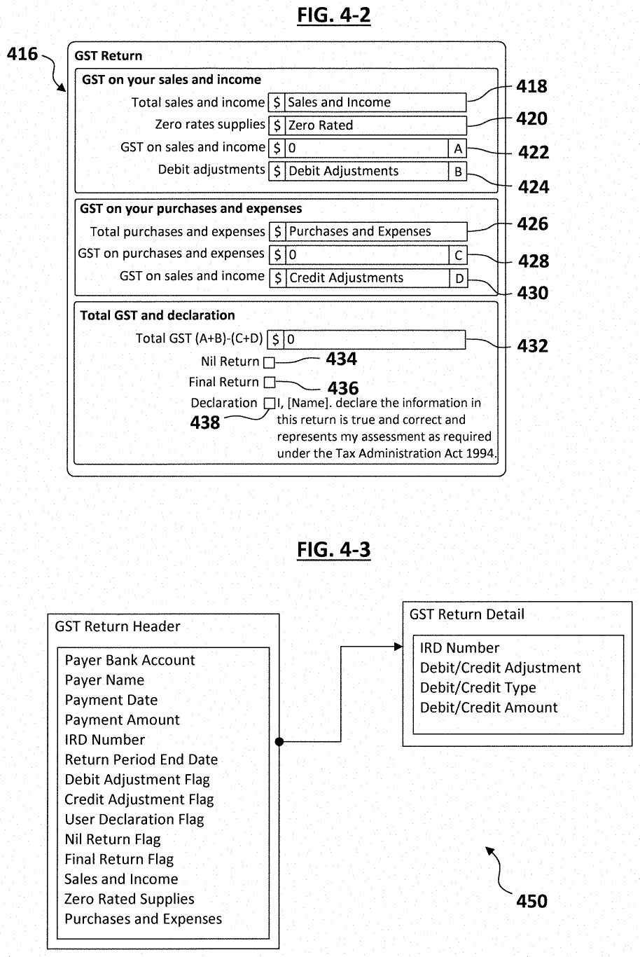

Known GST tax payments made using online banking require, as per IR 584, the payee name and bank account number, amount, the IRD number of the person or organisation the payment is for (to be entered into the ‘Particulars’ field), and a code entered into the ‘Code’ field (for example, ‘GST’ followed by the period end date for this payment). Referring to FIG. 4-1, an online banking service provides a GST payment interface 400 according to an exemplary embodiment of the present disclosure. The GST payment interface 400 includes a GST number field 402, GST period end date selector 404, payment amount field 406, payer particulars field 408a, payee particulars field 408b, payer code field 410a, payee code field 410b, payer reference field 412a, and payee reference field 412b.

The GST payment interface 400 also includes a tax return submission selector 414, selection of which opens a data entry form 416 illustrated in FIG. 4-2. The data entry form 416 includes a total sales and income field 418, and zero rated supplies field 420, for entry of data by the user. From this data, a GST on sales and income field 422 may be automatically populated. The data entry form 416 further includes a debit adjustments field 424 for entry of data by the user.

The data entry form 416 includes a total purchases and expenses field 426 for entry of data by the user, from which a GST on purchases and expenses field 428 may be automatically populated. The data entry form 416 further includes a credit adjustments field 430 for entry of data by the user.

The data entry form 416 automatically populates a total GST field 432 based on the entered data. A nil return selector 434 and final return selector 436 are also provided, together with a declaration checkbox 438.

Selection of the declaration checkbox 438 initiates encoding of the data. A protocol for the GST payment determines the arrangement of the various data elements, encoding of the data using Base64 encoding, and population of the payee particulars field 408b, payee code field 410b, and payee reference field 412b with the encoded data. The payment amount field 406 is also populated based on the calculated GST amount. Where the user is eligible for a refund, a nominal transaction amount (for example, $0.01) is used in order to transmit the tax return to the IRD.

Exemplary transaction lines for the payments appearing in the user's bank accounts are shown in the table below:

TABLE 2

| Date | Name | Particulars | Code | Reference | Amount |
|---|---|---|---|---|---|
| DD/MM/YYYY | INLAND | [IRD | GST [period | | −[value of |
| | REVENUE | number] | end date] | | payment of |
| | | | | | tax owed] |
| DD/MM/YYYY | INLAND | [IRD | GST [period | CR. REQ. | −0.01 |
| | REVENUE | number] | end date] | | |

The reference “CR. REQ” of the second entry indicates that the payment relates to a request for tax credit or refund. Corresponding transaction lines for the payments appearing in the IRD's bank accounts are shown in the table below:

TABLE 3

| Date | Name | Particulars | Code | Reference | Amount |
|---|---|---|---|---|---|
| DD/MM/YYYY | [NAME OF | [First portion | [Second | [Third portion | [value of |
| | PAYER] | of encoded | portion of | of encoded | payment of |
| | | data] | encoded data] | data] | tax owed] |
| DD/MM/YYYY | [NAME OF | [First portion | [Second | [Third portion | 0.01 |
| | PAYER] | of encoded | portion of | of encoded | |
| | | data] | encoded data] | data] | |

Further data can be extracted from the encoded data in the payee particulars, code and reference fields (along with the other transaction data) by way of query views as represented in FIG. 4-3, which shows transaction data consolidated into an entity relationship diagram 450.

By utilising the present disclosure, a tax return may be submitted and paid in the same process. It is envisaged that this may reduce the administrative burden on the payer (or their representative) in completing the return, as well as reducing the resource required by the taxation agency to complete reconciliation processes. Further, records of the tax return and associated payment are stored at the same location—and these records are duplicated between the parties involved.

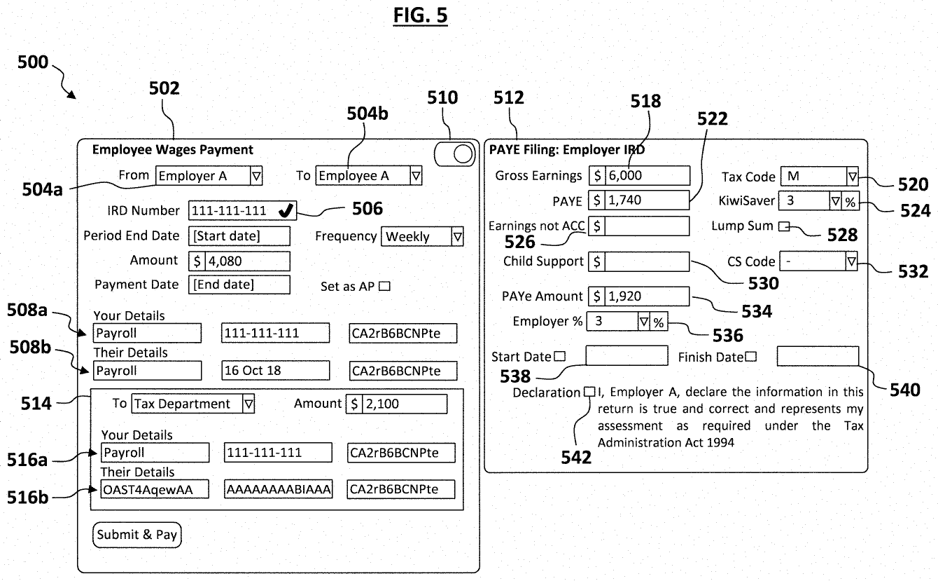

FIG. 5 illustrates an exemplary embodiment in which the payment transaction relates to withholding tax on income payments to employees—i.e. pay-as-you-earn (PAYE). An online banking service provides a payroll payment interface 500 according to an exemplary embodiment of the present disclosure. The payroll payment interface 500 includes a payment section 502, including employer selector 504a and employee selector 504b, and a IRD number field 506 automatically populated with the IRD number of the selected employee. Payer text fields 508a and payee text fields 508b are also provided.

The payroll payment interface 500 also includes a PAYE submission selector 510, selection of which opens a data entry form 512, and a PAYE payment section 514 having payer text fields 516a and payee text fields 516b. The data entry form 512 includes a gross earnings field 518, a tax code selector 520 (where selection of a student loan related code triggers display of a field for entry of student loan deductions), a PAYE field 522, superannuation or voluntary saving contribution selector 524, an earnings not liable for ACC earners' levy field 526, a lump sum acknowledgement selector 528, a child support deductions field 530, a child support code selector 532, a calculated PAYE owing field 534, an employer contribution selector 536, a start date field 538, and a finish date field 540. The data entry form 512 also includes a declaration checkbox 542.

Selection of the declaration checkbox 542 initiates encoding of the data. A protocol for the PAYE payment determines the arrangement of the various data elements, encoding of the data using Base64 encoding, and population of the payer text fields 516a and payee text fields 516b with the encoded data. The payer text fields 508a and payee text fields 508b for the payment to the employee may also be populated with at least a portion of the encoded data. In submitting payment to the employee, a corresponding payment for the PAYE component is also made to the IRD.

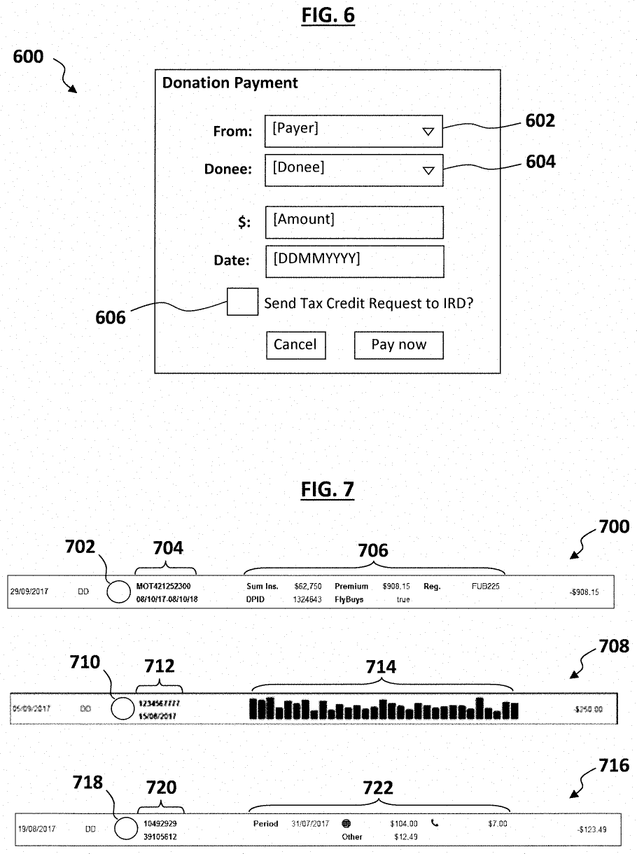

FIG. 6 illustrates an exemplary embodiment in which the payment transaction relates to a payment to an approved charitable organisation, and includes a request for a donation tax credit (also known as a charitable contribution deduction) from a taxation authority. An online banking service provides a donation payment interface 600 according to an exemplary embodiment of the present disclosure. The donation payment interface 600 includes a payer selection field 602. The record of each available payer may include information required to complete a request for a donation tax credit.

The donation payment interface 600 includes a donee selection field 604, providing means for selecting a donee which is registered with the taxation authority. The donation payment interface 600 also provides a tax credit request selector 606, such that a payment transaction is made to the taxation authority using a nominal payment value on making a donation to the donee. The payment transaction made to the taxation authority includes text fields populated with encoded data in accordance with the present disclosure, sufficient to complete the documentation associated with such a request.

Exemplary transaction lines for the payments appearing in the user's bank accounts are shown in the table below:

TABLE 4

| Date | Name | Particulars | Code | Reference | Amount |
|---|---|---|---|---|---|
| DD/MM/YYYY | [Donee] | [IRD | [Donee | [value of | −[value of |
| | | number] | identifier] | donation] | payment to |
| | | | | | donee] |
| DD/MM/YYYY | INLAND | [IRD | [Donee | [value of | −0.01 |
| | REVENUE | number] | identifier] | donation] | |

A corresponding transaction line for the payment appearing in the donee's bank accounts is shown in the table below:

TABLE 5

| Date | Name | Particulars | Code | Reference | Amount |
|---|---|---|---|---|---|
| DD/MM/YYYY | [NAME OF | [IRD | [Donee | [value of | [value of |
| | PAYER] | number] | identifier] | donation] | payment to |
| | | | | | donee] |

A corresponding transaction line for the payment appearing in the IRD's bank accounts is shown in the table below:

TABLE 6

| Date | Name | Particulars | Code | Reference | Amount |
|---|---|---|---|---|---|
| DD/MM/YYYY | [NAME OF | [IRD | [Donee | [value of | 0.01 |
| | PAYER] | number] | identifier] | donation] | |

In an exemplary embodiment, the present disclosure may be applied to payment of withholding tax on interest to a taxation authority. Payment of interest subject to a withholding tax includes a first payment transaction to an account relating to a deposit accruing interest (e.g. a user's bank account), and a second payment transaction to a taxation authority (e.g. IRD), with encoded dataset of at least the second payment transaction including requisite information to complete a withholding tax withholding certificate. Exemplary transaction lines for the payments appearing in the user's bank account are shown in the table below:

TABLE 7

| | | | | | | |
|---|---|---|---|---|---|---|
| Date | Name | Particulars | Code | Reference | Debit | Credit |

| | | | | | |
|---|---|---|---|---|---|
| DD/MM/YYYY | [BANK] | CR. | [DDMMYYYY] | | [value of |
| | | INT TO | | | interest] |
| DD/MM/YYYY | INLAND | IRD: | INTEREST | [value of | |
| | REVENUE | TAX ON | | RWT on | |
| | | | | interest] | |

FIG. 7 illustrates an exemplary embodiment of the present disclosure in which encoded datasets are used to enrich transaction line items of an online banking interface (typically displayed in a plain text format). By way of example, a first transaction line item 700 relating to a direct debit from an insurance company includes a logo 702 identifying the insurer, a policy identification section 704 in which the policy number and term are provided, and a policy detail section 706 in which additional details regarding the policy are provided. As a further example a second transaction line item 708 relating to a direct debit from a power company includes a logo 710 identifying the power company, an invoice identification section 712 in which details such as invoice number and period may be provided, and a graphical representation 714 of power consumption over the relevant period. As a further example, a third transaction line item 716 relating to a direct debit from a telecommunications company includes a logo 718 identifying the company, a customer identification section 720 in which the customer number is provided, and an invoice detail section 722 in which additional details regarding the charges incurred are provided.

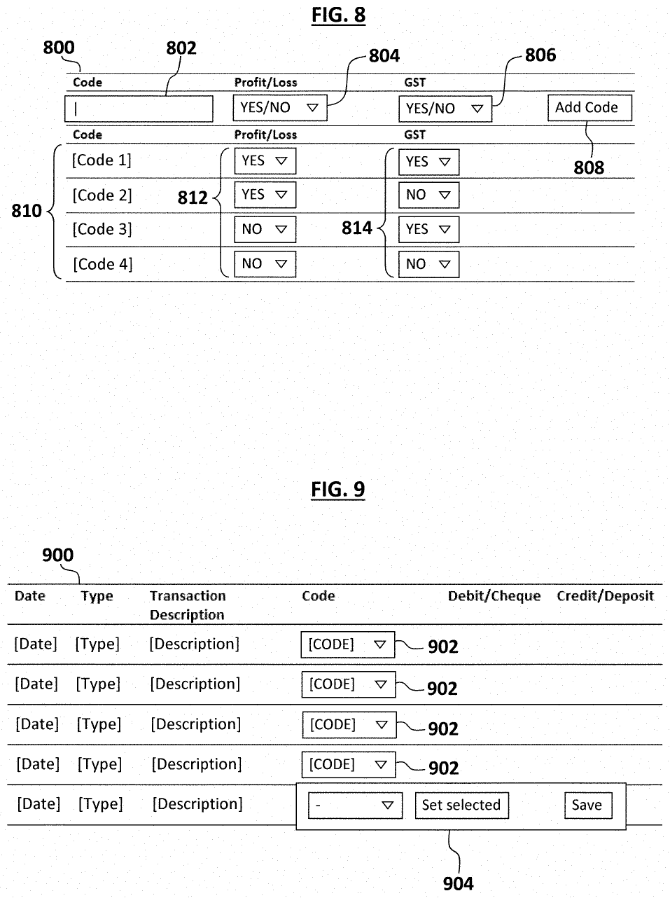

FIG. 8 illustrates an exemplary account code interface 800, for creation and modification of accounting codes to be applied to transactions on the user's bank account. The account code interface 800 includes a new code name entry field 802, a profit and loss selector 804, a sales tax selector 806, and a code entry confirmation button 808. Existing codes 810 may be modified using selectors 812 and 814. The account code is recorded within the user's bank account using one or more nominal payment transactions populated with encoded data for the account code.

In exemplary embodiments, a standardised transaction identifier may used within the system such that a transaction can be identified by its contents rather than by a local identifier. In an exemplary embodiment, creation of a transaction identifier may include determining an Apply Date Index by: i) selecting all transactions on the same date, ii) ordering by ascending date and time, iii) ordering by ascending “[Name] & [Particulars] & [Code] & [Reference]”, iv) ordering by amount, v) finding the zero-based index of the transaction within the resulting list, and vi) returning the index as a 2-character hexadecimal value. The Apply Date Index may then be used with the date of the transaction to form the transaction identifier, which may be used to identify coding applied to each transaction.

Application of an accounting code may be performed using one or more nominal payment transactions. A plurality of coding types may be used, including (but not limited to): code apply, code split, tax code apply, journal, and note.

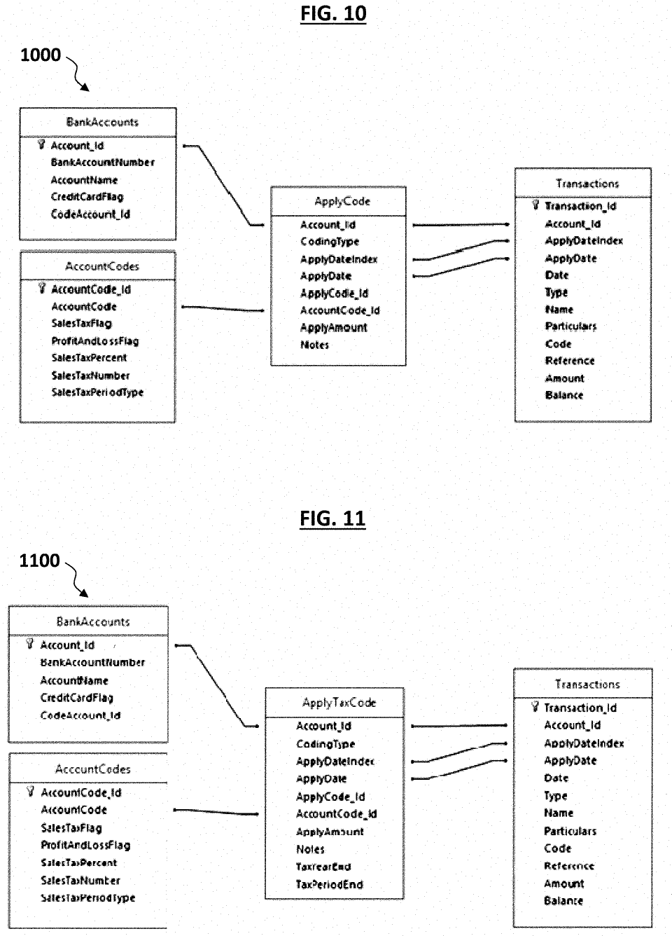

Referring to FIG. 9, an exemplary code application interface 900 may be provided within the online banking service, displaying an assigned accounting code 902 for each line item. Selection of an accounting code 902 displays a code apply control function 904, with which an accounting code may be applied to a transaction (or modified from a previously applied code). An apply code record is generated in the form of a nominal transaction, having a code application identifier which is incremented for each application of an accounting code to the parent transaction—creating a permanent audit trail. It is noted that the code apply type is used where the accounting code is to be applied to the whole parent transaction amount, while the code split type is used to apply an accounting code to a portion of the parent transaction amount. FIG. 10 illustrates the transaction data consolidated into an entity relationship diagram 1000, when applying a code or codes to a transaction.

The tax code apply type may be used when a tax correction is required, coding an income tax or sales tax payment to a different tax period or to a different registered tax number. FIG. 11 illustrates the transaction data consolidated into an entity relationship diagram 1100, when applying a code or codes to a transaction associated with a tax payment.

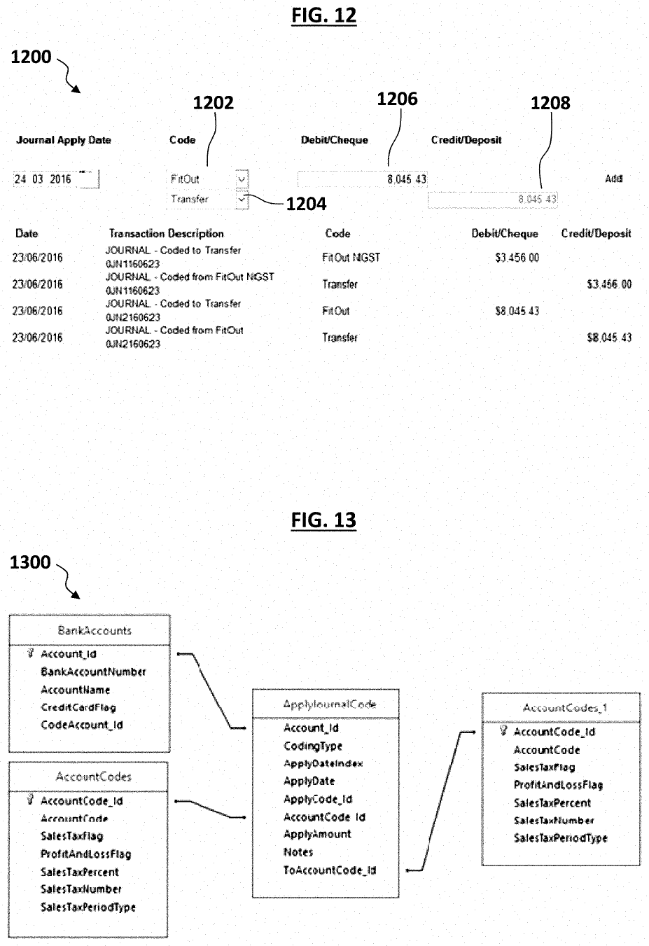

Referring to FIG. 12, an exemplary journal entry creation interface 1200 may be provided within the online banking service, using a nominal payment transaction of the present disclosure to provide an accounting journal entry. The journal entry creation interface 1200 includes a debit code selector 1202, and a credit code selector 1204 for selection of the accounting codes the journal entry is to apply to. A debit field 1206 is provided, with credit field 1208 automatically populated based on the value entered into the debit field 1206. FIG. 13 illustrates the transaction data consolidated into an entity relationship diagram 1300, when creating a journal.

It should be appreciated that the inclusion of encoded data in payment transactions as described herein may be used to record a range of data within the system. Further examples include customised notes, and account information which might be referenced (for example, identification of a bank account).

The various transactions form a single table within the online banking service, where each row has fields utilised by the system of the present disclosure to store encoded data. The decoded information, within the row, may form the header and/or records of a relational database as illustrated. This data may also have a relationship to the decoded data within one or many other transactions in the same user's transaction table. Thus, from a single table (or vertical database) with a constrained record set, a more complex relational database can be formed.

In examples, the vertical database formed by the collection of encoded transactions may also be described as a non-relational NoSQL document store database. The contents of each encoded transaction forms the data for an individual document, the definition of which is described by a predefined protocol. An encoded identification within the encoded free text fields, and the supporting transaction fields, form the data required to identify the predefined protocol. Each encoded transaction record may have a different protocol. Therefore, a table of encoded transactions (once decoded) will form a collection of documents with varying definitions. As a result, the collection of documents forms a non-relational NoSQL document store database.

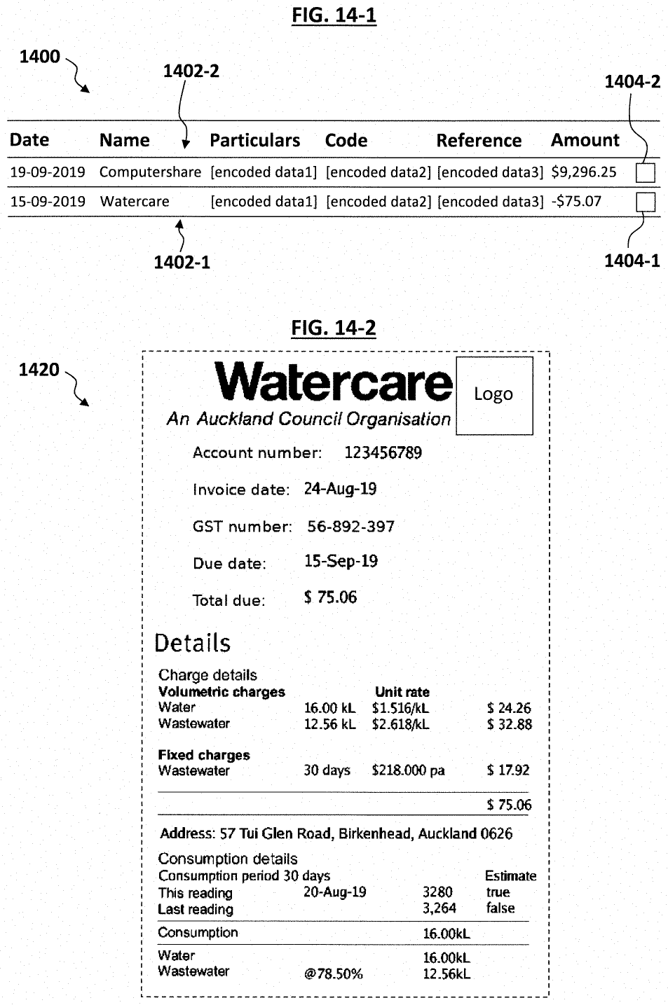

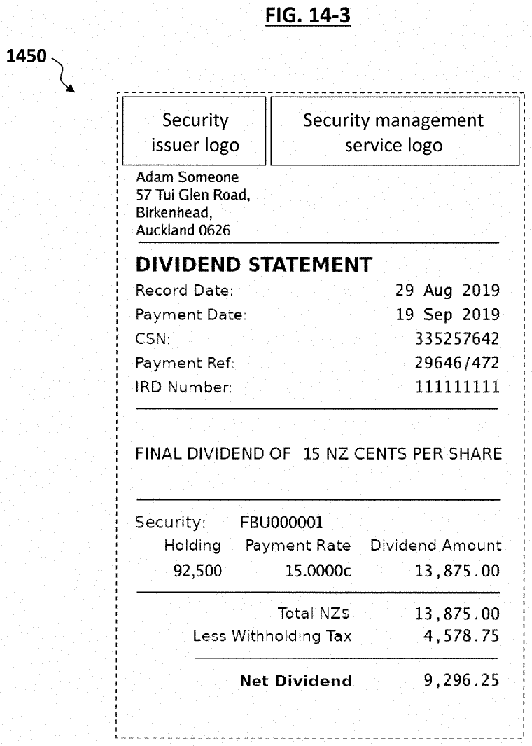

Referring to FIG. 14-1, an exemplary online banking user interface 1400 has a first transaction line 1402-1 and second transaction line 1402-2. Each of the first transaction line 1402-1 and second transaction line 1402-2 have encoded data ([encoded data1], [encoded data2], [encoded data3]) in the “Particulars”, “Code”, and “Reference” free text fields. Each of the first transaction line 1402-1 and second transaction line 1402-2 also includes a selectable document viewing icon 1404-1 and 1404-2 respectively, selection of which displays a document associated with the transaction line.

In this example, the first transaction line 1402-1 relates to the user's payment of local council charges for water utilities. On decoding of the data, a protocol for processing of the data is identified, and used to produce a receipt 1420 for the transaction (as shown in FIG. 14-2). In addition to values of particulars encoded into the data (for example: an account number, and values for the various charge details), the decoded data may identify artifacts to be utilised in generating the document (for example, document templates). Further, external APIs may be called to obtain additional data. For example, the encoded data may include a numerical Delivery Point Identifier associated with a specific delivery address, and a postal service API may be called with the Delivery Point Identifier to obtain full address details.

The second transaction line 1402-2 relates to payment of dividends to the user from a securities management service. On decoding of the data, a protocol for processing of the data is identified, and used to produce a dividend statement 1450 for the transaction (as shown in FIG. 14-3). In addition to values of particulars encoded into the data (for example: an IRD number, a holding value, a payment rate, and a withholding tax rate), the decoded data may identify artifacts to be utilised in generating the document (for example, document templates). Further, the protocol may define processing steps such as calculation of the dividend amount based on the holding value and payment rate, and calculation of withholding tax and net dividend. Further, external APIs may be called to obtain additional data. For example, the encoded data may include a numerical Delivery Point Identifier associated with a specific delivery address, and a postal service API may be called with the Delivery Point Identifier to obtain full address details.

For a firmware and/or software (also known as a computer program) implementation, the techniques of the present disclosure may be implemented as instructions (for example, procedures, functions, and so on) that perform the functions described. It should be appreciated that the present disclosure is not described with reference to any particular programming languages, and that a variety of programming languages could be used to implement the present invention. The firmware and/or software codes may be stored in a memory, or embodied in any other processor readable medium, and executed by a processor or processors. The memory may be implemented within the processor or external to the processor. A general purpose processor may be a microprocessor, but in the alternative, the processor may be any processor, controller, microcontroller, or state machine. A processor may also be implemented as a combination of computing devices, for example, a combination of a digital signal processor (DSP) and a microprocessor, a plurality of microprocessors, one or more microprocessors in conjunction with a DSP core, or any other such configuration. The processors may function in conjunction with servers, whether cloud based or dedicated, and network connections as known in the art.

In various embodiments, one or more cloud computing environments may be used to create, and/or deploy, and/or operate at least part of the software system that can be any form of cloud computing environment, for example: a public cloud, a private cloud, a virtual private network (VPN), a subnet, a Virtual Private Cloud (VPC), or any other cloud-based infrastructure known in the art. It should be appreciated that a service may utilize, and interface with, multiple cloud computing environments.

The steps of a method, process, or algorithm described in connection with the present disclosure may be embodied directly in hardware, in a software module executed by one or more processors, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

Reference throughout this specification to “one embodiment” or “an embodiment” (or the like) means that a particular feature, structure, or characteristic described in connection with the embodiment is included in at least one embodiment of the disclosure. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the foregoing description, numerous specific details are provided to give a thorough understanding of the exemplary embodiments. One skilled in the relevant art may well recognize, however, that embodiments of the disclosure can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the disclosure will be best understood by reference to the figures. The foregoing description is intended only by way of example and simply illustrates certain selected exemplary embodiments of the disclosure. It should be noted that the flowchart and block diagrams in the figures illustrate the architecture, functionality, and operation of possible implementations of systems, apparatuses, methods and computer program products according to various embodiments of the disclosure. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Throughout this specification, the word “comprise” or “include”, or variations thereof such as “comprises”, “includes”, “comprising” or “including” will be understood to imply the inclusion of a stated element, integer or step, or group of elements integers or steps, but not the exclusion of any other element, integer or step, or group of elements, integers or steps, that is to say, in the sense of “including, but not limited to”.

Embodiments described herein may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the scope of the disclosure and without diminishing its attendant advantages. It is therefore intended that such changes and modifications be included within the present disclosure.

1. A method for providing data with a payment transaction, the method comprising: utilizing at least one processor to execute computer code that performs the steps of:
receiving a dataset for inclusion with a payment transaction;
encoding received dataset;
populating at least one free text field of a payment transaction interface with the encoded dataset; and
performing the payment transaction.

2. The method of claim 1, wherein at least a portion of the dataset is extracted from a form.

3. The method of claim 1, wherein the received dataset is encoded using binary-to-text encoding.

4. The method of claim 1, wherein the encoding of the received dataset is performed in accordance with one of a plurality of protocols, wherein the protocols are stored as data encoded in one or more payment transactions.

5. (canceled)

6. The method of claim 1, wherein the payment transaction includes control information, the control information including one or more of: a protocol type identifier identifying a protocol for encoding and/or decoding the dataset, and a transaction type identifier for identifying the payment transaction as including an encoded dataset.

7. (canceled)

8. The method of claim 1, wherein the encoded dataset is provided in more than one payment transaction.

9. The method of claim 1, including recording incoming and outgoing payment transactions including encoding datasets, wherein records produced from the incoming and outgoing payment transactions act as a database.

10. The method of claim 9, wherein at least one of the records resulting from the payment transaction includes an index key for identifying the payment transaction when the dataset in the payment transaction is broken into header and record tables.

11. The method of claim 1, including populating a digital tax return form, and providing details of the populated tax return form as at least part of the dataset to be encoded for inclusion in a payment transaction for the value of tax owing with the return.

12. The method of claim 1, including inputting requisite information to complete a request for a donation tax credit, making a first payment transaction to an approved charitable organization, wherein making the first payment transaction initiates a second payment transaction to a taxation authority, wherein the encoded dataset of the second payment transaction includes the requisite information to complete a request for a donation tax credit.

13. The method of claim 1, wherein the method includes making a first payment transaction to an account relating to a deposit accruing interest, and making a second payment transaction to a taxation authority, wherein the encoded dataset of the second payment transaction includes requisite information to complete a withholding tax certificate.

14. The method of claim 1, wherein the method includes making a first payment transaction to an account of an employee, wherein the first payment transaction is payment of income to the employee, and making a second payment transaction to a taxation authority, wherein the encoded dataset of the second payment transaction includes requisite information to complete documentation requirements relating to withholding tax on income payments.

15. The method of claim 1, wherein the payment transaction establishes one or more accounting codes to be applied to other payment transactions.

16. The method of claim 15, wherein the payment transaction applies an accounting code to an earlier payment transaction to produce an accounting coded record, wherein the encoded dataset of the payment transaction includes one or more of: data identifying the earlier transaction, and data uniquely identifying the accounting coded record.

17. (canceled)

18. The method of claim 1, wherein the payment transaction applies a tax treatment to an earlier payment transaction to produce a tax treatment record.

19. The method of claim 1, wherein the payment transaction provides an accounting journal entry.

20. The method of claim 1, wherein the payment transaction applies a customised note to an earlier payment transaction.

21. The method of claim 1, wherein the encoded dataset includes instructions for enriching a transaction line item of an online banking interface, wherein the instructions for enriching the transaction line item include one or more of: identification of at least one visual element for the transaction line item, identification of at least one graphical element for display in the transaction line item, and identification of text for display in the transaction line item.

22-28. (canceled)

29. A system for providing data with a payment transaction, the system comprising: at least one processor; and a computer readable storage medium having computer readable program code embodied therewith and executable by the at least one processor, the computer readable program code comprising:
computer readable program code that receives a dataset for inclusion with a payment transaction;
computer readable program code that encodes the received dataset;
computer readable program code that populates at least one free text field of a payment transaction interface with the encoded dataset; and
computer readable program code that performs the payment transaction.

30. A computer program product for providing data with a payment transaction, the computer program product comprising a computer readable storage medium having computer readable program code embodied therewith, the computer readable program code comprising:
computer readable program code that receives a dataset for inclusion with a payment transaction;
computer readable program code that encodes the received dataset;
computer readable program code that populates at least one free text field of a payment transaction interface with the encoded dataset; and
computer readable program code that performs the payment transaction.
